(19) United States
(12) Patent Application Publication
(10) Pub. No.: US 2025/0391218 A1
(43) Pub. Date: Dec. 25, 2025

(54) Verbose Logic and Accuracy Testing

(71) Applicants: THE REGENTS OF THE UNIVERSITY OF MICHIGAN, Ann Arbor, MI (US); The Board of Trustees of the University of Illinois, Urbana, IL (US)

(72) Inventors: Bradley Sturt, Urbana, IL (US); Braden L. Crimmins, Ann Arbor, MI (US); John Alexander Halderman, Ann Arbor, MI (US)

(21) Appl. No.: 19/245,717

(22) Filed: Jun. 23, 2025

Related U.S. Application Data
(60) Provisional application No. 63/662,636, filed on Jun. 21, 2024.

(51) Int. Cl. G07C 13/00; G06Q 50/26

(52) U.S. Cl. CPC G07C 13/00; G06Q 50/26; G06Q 2230/00

(57) ABSTRACT

The following relates generally to checking electronic voting machines and/or electronic voting systems. In some embodiments, one or more processors: (i) receive information of a plurality of ballots, the information of the plurality of ballots including at least information of a first ballot and information of a second ballot; (ii) aggregate the information of the plurality of ballots; and (iii) produce an output based on the aggregated information of the plurality of ballots.

### CROSS REFERENCE TO RELATED APPLICATIONS

This application claims the benefit of U.S. Provisional Application No. 63/662,636, entitled “Verbose Logic and Accuracy Testing” (filed Jun. 21, 2024), the entirety of which is incorporated by reference herein.

### BACKGROUND

When a voting machine is working properly, the voting machine may be fed filled-out ballots, and, when voting is complete, will print out the correct number of votes that were cast for each candidate based on the ballots that were fed into the machine. Before each election, officials test machines by casting a set of ballots with known votes and ensuring that the machine arrives at the correct tally. However, current systems for testing voting machines have certain drawbacks. Namely, current systems for testing voting machines (1) may fail to detect certain errors, which creates potential for embarrassing or harmful issues on election day and (2) may require significant time or use of many test ballots, which imposes additional costs on election administrators.

### SUMMARY

The following relates generally to testing electronic voting machines and/or electronic voting systems.

In one aspect, a computer-implemented method for use in testing a voting system and/or voting machine through the use of test ballots may be provided. In one example, the method may include a voting machine: (1) receiving, via an optical scanner or camera and one or more processors, information associated with a ballot, (2) interpreting, via one or more processors and machine memory, the contents of the ballot, e.g. to determine which candidates should receive votes or to identify the locations of certain text or symbols on the ballot; and/or (3) outputting, via one or more processors and an attached digital screen, physical media printer, or data port information reflecting its interpretation for use in the testing procedure. The method may include additional, fewer, or alternate actions, including those discussed elsewhere herein.

In another example, the method may include (1) receiving, via an optical scanner or camera and one or more processors, information associated with a ballot; (2) interpreting, via one or more processors and machine memory, the contents of the ballot; (3) storing this interpretation to machine memory; (4) repeating steps 1 through 3 with one or more additional ballots; (5) synthesizing, via one or more processors and access to machine memory, the stored interpretation of each ballot so as to retain information which would be lost by mere tabulation; and/or (6) outputting, via one or more processors and an attached digital screen, physical media printer, or data port information reflecting or committing to this synthesis of the interpretations. The method may include additional, fewer, or alternate actions, including those discussed elsewhere herein.

In another aspect, a computer-implemented method for use in testing a voting system and/or voting machine without the use of test ballots may be provided. In one example, the method may include a voting machine: (1) receiving, via a data port, a configuration specifying how a voting machine should interpret ballots in an upcoming election; (2) interpreting or processing, via one or more processors, the contents of the configuration; (3) evaluating, via one or more processors, whether the configuration satisfies configuration rules (e.g., that all voting targets which appear on the ballot are the same size; that candidates in the same contest have targets that are located near one another on the ballot; that each target maps to precisely one candidate and each candidate has precisely one target; that no two targets overlap; that the order of contests and sections of the ballot conforms to the jurisdiction's rules; etc.); and/or (4) outputting, via one or more processors and an attached digital screen, physical media printer, or data port information reflecting or committing to this interpretation or processed configuration. The method may include additional, fewer, or alternate actions, including those discussed elsewhere herein.

In another aspect, a computer-implemented method for use in testing an election management system or other auxiliary computational system may be provided. In one example, the method may include an election management system: (1) receiving, via a data port, manual data entry, wireless connection, optical character recognition-based parsing of a ballot or ballot proof, or other interface a configuration specifying what will appear on ballots during an upcoming election; (2) interpreting, via one or more processors, the contents of the configuration; (3) evaluating, via one or more processors, whether the configuration satisfies configuration rules (e.g., that the expected parties appear on the ballot; that candidates' names are spelled consistently across different ballots for the same election; that every ballot contains the expected federal and statewide contests; that the configured order of contests conforms to the jurisdiction's rules; etc.); and/or (4) outputting, via one or more processors and an attached digital screen, physical media printer, or data port information reflecting or committing to the details of the configuration's satisfaction of these rules. The method may include additional, fewer, or alternate actions, including those discussed elsewhere herein.

In another aspect, a computer device configured for use in checking a voting system and/or voting machine may be provided. In one example, the computer device may include one or more processors configured to: (1) receive information of one or a plurality of ballots; (2) interpret the information of the ballot or ballots; (3) in the case of multiple ballots, synthesize these interpretations so as to retain or present information that would be lost by mere tabulation; and (4) produce an output based on the synthesized information. The computer device may include additional, less, or alternate functionality, including that discussed elsewhere herein.

In yet another aspect, a computer system configured for use in checking a voting system and/or voting machine may be provided. In one example, the computer system may include: one or more processors; and/or one or more non-transitory memories coupled to the one or more processors. The one or more non-transitory memories may include computer-executable instructions stored therein that, when executed by the one or more processors, may cause the one or more processors to: (1) receive information of one or a plurality of ballots; (2) interpret the information of the ballot or ballots; (3) in the case of multiple ballots, synthesize these interpretations so as to retain or present information that would be lost by mere tabulation; and/or (4) produce an output based on the synthesized information. The computer system may include additional, less, or alternate functionality, including that discussed elsewhere herein.

### BRIEF DESCRIPTION OF THE DRAWINGS

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 shows a system for testing a voting machine, in an example.

FIG. 2 shows an example method for testing a voting machine.

FIG. 3 shows an example method for checking a configuration specifying how a voting machine should interpret ballots.

### DETAILED DESCRIPTION

Current systems for testing electronic voting machines have certain drawbacks. For example, the output of current systems is lacking. In one such example, a current system produces only the aggregated number of votes cast for each candidate when ballots are scanned through the machine; the administrator (e.g., the human tester of the voting machine) cannot, for example, view the information of how the machine interpreted individual test ballots.

In a second example, the administrator is able to view information of individual test ballots, but the process for doing so is cumbersome or impractical. For instance, the process to view individual test ballots may be cumbersome because it may include physically removing a memory card from a voting machine and attaching it to a different system. Additionally or alternatively, the process may be impractical because a state (or other) law prohibits removing such memory cards from voting machines subsequent to testing.

The techniques disclosed herein provide solutions to these problems and others. For example, techniques disclosed herein provide an output that may include additional information beyond a mere tally of the number of votes received by each candidate. In another example, techniques described herein advantageously provide additional information without the need to physically remove a memory card from a voting machine.

The techniques described herein have further technical advantages as well. For example, as will be explained below, techniques described herein detect certain types of errors that previous systems were unable to detect. Some such examples of errors that previous systems were unable to detect include: detecting whether a voting machine has been configured, incorrectly, to map multiple voting targets to a single candidate; detecting whether a voting machine has been configured, incorrectly, to have a straight party ticket; and detecting whether a machine has been configured, incorrectly, to apply incorrect logic for straight party elections. By addressing these problems and others, the techniques described herein improve accuracy and reliability of the system.

Moreover, advantageously, techniques described herein enable detection of errors that current testing procedures would not catch. Administrators currently test voting machines by scanning a set of test ballots and comparing the aggregated number of votes for each candidate to the amount that are expected. But this misses important errors. For example, when multiple candidates receive the same number of votes in the course of a test, such a procedure might not detect that the machine has been misconfigured to swap votes between those candidates. By enabling the machine to provide more than the mere aggregate tally of votes, the methods described herein allow administrators to disambiguate these cases and detect such errors.

In addition, some embodiments described herein permit the detection and diagnosis of more subtle forms of configuration errors as well. For example, it is possible that a voting machine could be configured to expect vote markings for a candidate in a region that only partially overlaps with the actual voting target, so that a vote is only counted for the candidate when, e.g., a mark fills the rightmost third of the voting target. Such a configuration error would be difficult to catch with a standard testing procedure, and could cause ballots to be miscounted if some voters incompletely mark their ballots (for example with a check or an X, instead of filling in the target completely). Such an error would not just be difficult to detect with a current test deck; it would also be almost impossible to diagnose, i.e., to recognize the cause of the error simply from an aggregated vote total. The methods described herein, however, allow the voting machine to output a visual depiction of what it “sees” in each voting target during the testing phase, which make this issue easy to detect and diagnose.

### Example System

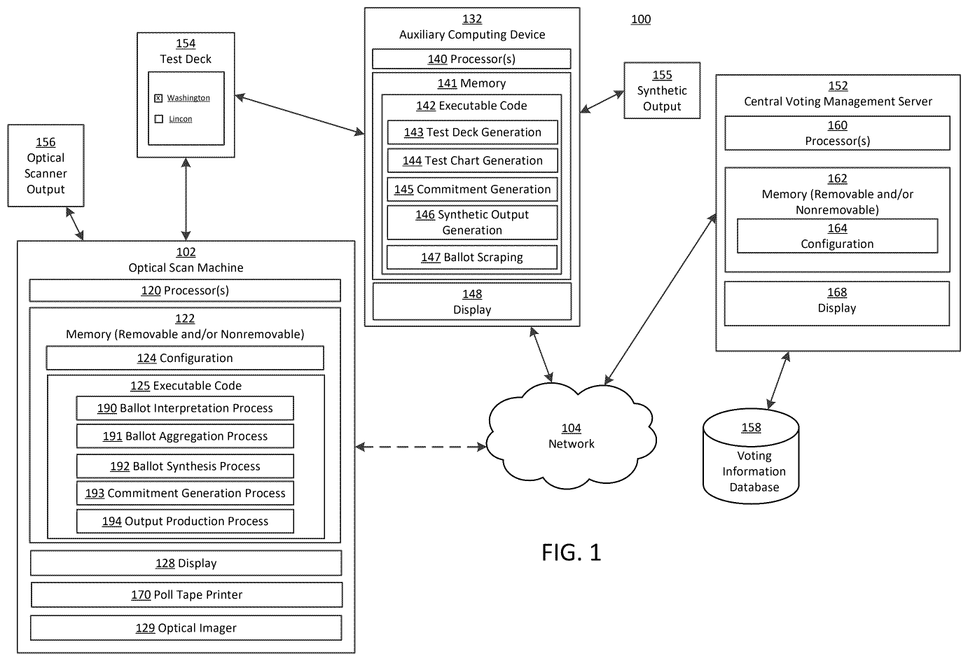

FIG. 1 illustrates an example system 100 for testing a voting machine. The system 100 includes auxiliary computing device 132, which may perform techniques described herein to test or assist in testing an optical scan machine 102.

The auxiliary computing device 132 includes one or more processors 140, which may represent a CPU-type processing unit(s), a GPU-type processing unit(s), a field-programmable gate array (FPGA), another class of digital signal processor (DSP), or other hardware logic components that can be driven by a CPU. The auxiliary computing device 132 further includes memory 141, which may include executable computer-readable code stored 142 thereon for programming a computer (e.g., comprising a processor(s) and GPU(s)) to the techniques herein. Examples of such computer-readable storage media include a hard disk, a solid state storage device/media, a CD-ROM, digital versatile disks (DVDs), an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. The executable computer-readable code stored on the memory 141 may include instructions for executing various applications 142, such as test deck generation 143, test chart generation 144, commitment generation 145, synthetic output generation 146, and ballot scraping 147.

The optical scan machine 102 includes one or more processors 120, which may represent a CPU-type processing unit(s), a GPU-type processing unit(s), a field-programmable gate array (FPGA), another class of digital signal processor (DSP), or other hardware logic components that can be driven by a CPU. The optical scan machine 102 further includes memory 122, which may include executable computer-readable code stored thereon for programming a computer (e.g., comprising a processor(s) and GPU(s)) to the techniques herein. Examples of such computer-readable storage media include a hard disk, a solid state storage device/media, a CD-ROM, digital versatile disks (DVDs), an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. The executable computer-readable code stored on the memory 122 may include instructions for executing various applications, such as ballot interpretation 190, ballot aggregation 191, ballot synthesis 192, commitment generation 193, or output production 194.

The auxiliary computing device 132 may be associated with any suitable entity. For example, the auxiliary computing device 132 may be owned by a government entity (such as a state, federal, or local government) and used by the same or a government entity to test an optical scan machine 102. In another example, the auxiliary computing device 132 may be owned by a private company and used by the same or another private company to test an optical scan machine 102. In still other examples, the auxiliary computing device 132 may be owned by a private company and accessed or used by a government entity to test an optical scan machine 102.

The auxiliary computing device 132 may test or assist in testing an optical scan machine 102. For example, the auxiliary computing device 132 may execute a test deck generation process 143 on one or more processors 140 and produce a test deck 154. The auxiliary computing device 132 may also execute a synthetic output generation process 146, alone or in combination with other processes, and produce a synthetic output 155. The optical scan machine may then process the test deck 154 using optical imager 129 and some combination of executable processes like ballot interpretation 190, ballot aggregation 191, ballot synthesis 192, and commitment generation 193. The optical scan machine may then produce an optical scanner output 156 using a combination of the display 128, the poll tape printer 170, or removable memory 122 in connection with executable code like the output production subroutine 194. A human administrator or automated tool may then compare the optical scanner output to the synthetic output to confirm the accuracy of the machine's behavior.

The auxiliary computing device 132 requires details about an election or ballot as input for the test deck generation process 143. The details about an election or ballot may include: contests of the election (e.g., a presidential contest, a senate contest, etc.), candidate(s) in each contest, maximum number of allowed votes per contest, etc. Furthermore, this information may be received from any suitable source. In some examples, this information is in the form of an upload from a voting information database 158. In other examples, this information is in the form of a configuration, such as a configuration or other configuration, from the central voting management server 164. In still other examples, this information is obtained from the use of a ballot scraping subroutine 147 in connection with a visual depiction of a complete ballot, for example as a PDF document.

A test deck 154 is a set of one or more ballots marked with a known set of votes. In some examples, the contents of these ballots may be prepared by the auxiliary computing device 132 through execution of the test deck generation process 143. In other examples, the contents of these ballots may be prepared by hand according to the contents of the voting information database 158 and the testing features available on the optical scan machine 102.

A test deck generation process 143 is a software algorithm that prepares, using one or more processors 140 on the auxiliary computing device 132, a test deck 154. In some examples, this test deck is rendered into physical media by use of an attached printer. In other examples, this test deck is rendered digitally, for instance in a PDF document or a spreadsheet.

A synthetic output 155 is an output generated by administrator computing device 132 to facilitate the comparison of a machine's output to what output was expected from the election.

A synthetic output generation process 146 is a software algorithm that prepares, using one or more processors on the auxiliary computing device 132, a synthetic output 155. In some examples, the synthetic output 155 is rendered physically, for example in the form of a poll tape. In other examples, the synthetic output is rendered digitally, for instance in a PDF document.

An optical scanner output 156 is a physical or digital output from an optical scan machine 102 that reflects the contents of a processed test deck 154. In some examples, this output is rendered digitally through an attached display 128. In other examples, this output is rendered onto physical media through use of an attached poll tape printer 170. In yet other examples, this output is in the form of electronic data transferred via removable memory 122.

An optical scanner output production subroutine 194 is executable code that allows an optical scan machine 102 to render output. The output production subroutine 194 may also make use of other executable subroutines such as ballot synthesis 192 or commitment generation 193.

Additionally or alternatively, the optical scan machine 102 may undertake new steps to facilitate the testing of itself. For example, the optical scan machine may process information of a plurality of ballots using ballot aggregation subroutine 191, ballot synthesis subroutine 192, or commitment generation subroutine 193, and may produce an output using output production subroutine 194 along with attached display 128, poll tape printer 170, and/or removable memory 122 based on the aggregated information of the plurality of ballots. The optical scan machine 102 may additionally or alternatively process and output information relating to its configuration 124 using similar subroutines, providing direct information to the administrator as to how the machine has been configured.

The information of the plurality of ballots (e.g., information from individual ballots of the plurality of ballots, etc.) may include: contests of the election (e.g., a presidential contest, a senate contest, etc.), candidate(s) in each contest, maximum number of allowed votes per contest, etc. Furthermore, this information may be received by the optical scan machine 102 from any suitable source, such as the external voting information database 180 (e.g., a government database holding election information, etc.), internal voting information database 118 (e.g., a private database of a company of the optical scan machine 102, etc.). Additionally or alternatively, the election information may be held in the memory 122.

In addition, as will be described elsewhere herein, the optical scan machine 102 may have a test mode and a normal mode.

The example system 100 may have other measures of security, as well. For instance, only authorized elections officials may have access to components of the system 100, for example, using authorized user login. In addition, all traffic on any of the components in the example system 100 may be monitored for unauthorized access attempts. Furthermore, there may be routine backups of data created that may be later used to determine if data has been manipulated or changed. Furthermore, an overall authentication and encryption engine may be implemented to protect components of the system 100 against local or network attacks.

In some embodiments, the components of the example system 100 are connected via a network 104 (which may be a wired or wireless network, such as the internet). In various examples, the network 104 represents a secured, physical communication link between devices. For example, data may preferably be transferred to and from an optical scan machine/management server/auxiliary computing device using flash drives, removable memory cards, or other physical computer accessible storage media. Therefore, references herein to network are intended to include wired, wireless, or such physical storage media used for moving secured data between computing devices

In addition, although the example system 100 illustrates only one of many of the components, any number of components are contemplated (e.g., any number of optical scan machines, auxiliary computing devices, central voting management servers, test decks, voting information databases, etc.).

Furthermore, some embodiments account for when a ballot is marked with more votes than is allowed for a particular contest. For example, in a presidential contest, voters may be allowed to vote for only one candidate. Thus, in some jurisdictions, if more than one candidate for the presidential contest is marked on the ballot, a vote for president is not counted from the ballot. This is sometimes referred to as the overvote rule.

### Example Method

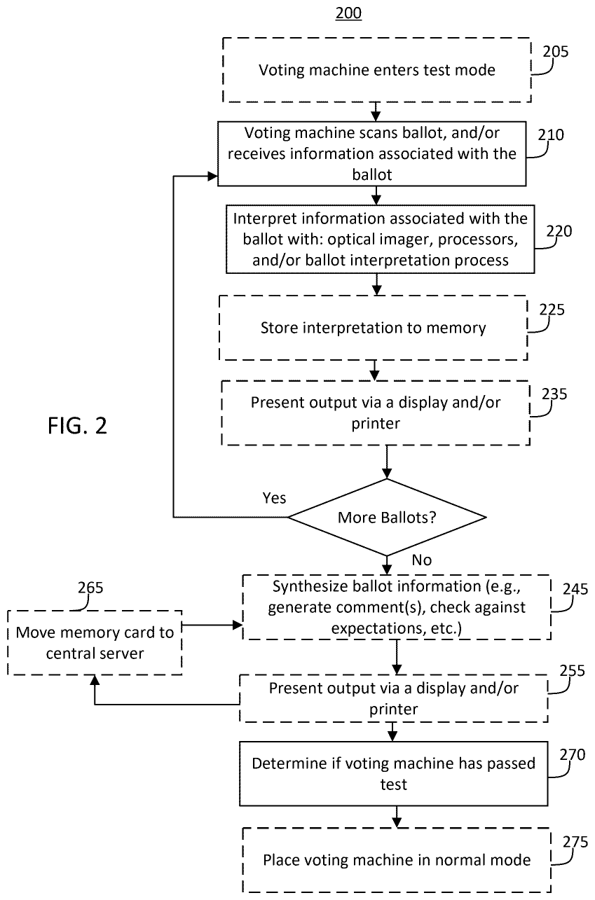

FIG. 2 illustrates an example overview flowchart 200 of a method for testing an optical scan machine 102. In some embodiments, the example method 200 may be performed wholly or partially by the optical scan machine 102 (e.g., via the one or more processors 120, the executable code 125, etc.). Additionally or alternatively, the example method 200 may be performed by a combination of the auxiliary computing device 132 and the optical scan machine 102.

The example method 200 may begin at optional block 205 where the optical scan machine 102 is placed in test mode. In some embodiments, in the test mode, the optical scan machine produces an output (e.g., as described with respect to block 255); whereas, in normal mode, the optical scan machine 102 does not produce the output. The optical scan machine 102 may be placed in the test mode by a human administrator. Alternatively, the optical scan machine 102 may be placed in the test mode via the configuration 124.

At block 210, the first ballot in the test deck 154 is received (e.g., at the optical scan machine 102's optical imager 129, at one or more processors 120, etc.). The ballot may contain markings as though the ballot were marked by a voter. The ballot may also contain other markings designed specifically for the testing functionalities available in the machine.

At block 220, the information on the first ballot in the test deck 154 is parsed by the optical scan machine 102 using one or more processors 120, available memory 122, and the ballot interpretation process 190. This process obtains information based on the way the first ballot is marked. In some examples, the optical scan machine 102 also uses the ballot aggregation process 191 to update the count of votes cast for each candidate during the test.

In some embodiments, at optional block 225, the optical scan machine 102 stores the interpretation produced by the previous step into the machine's memory 122. For example, the machine may record the time the ballot was cast, which candidates the ballot cast a vote for, and whether the ballot was interpreted as containing any special or ambiguous marks.

In some embodiments, especially those embodiments which involve use of a test mode, at optional block 235, the optical scan machine 102 presents output corresponding to the ballot that was just scanned. In some examples, this is done using the poll tape printer 170; in others, it is done using the machine's attached display 128. In one illustrative example, the optical scan machine 102 may display that the most recently cast ballot contained a vote for candidate A; thus, if the ballot cast did not in fact contain a vote for candidate A, the administrator would recognize that an error had occurred in the machine.

Following block 235, the administrator may check whether the test deck has been exhausted. If it has not, i.e. if there are test ballots which have not yet been scanned, the administrator will return to step 210 with respect to the next ballot, and repeat until no more ballots remain.

In some embodiments, at optional block 245, the information of the plurality of ballots is aggregated and synthesized (e.g., at the one or more processors 120, at the optical scan machine 102, at the ballot aggregation process 191, ballot synthesis process 192, commitment generation process 193, etc.). For example, the information from individual ballots of the plurality of ballots may be combined together. In some embodiments, this includes totaling votes for candidates from respective contests or compiling a report of the contents of each individual ballot that was cast. In some embodiments, this includes aggregating time information (e.g., timestamps indicating when ballots were cast and/or scanned) (e.g., aggregating into a single file). In some embodiments, this involves deriving a commitment (e.g., a hash) to the interpretation of the ballots that have been cast.

In some embodiments, at optional block 255, an output 156 is produced based on the aggregated information of the plurality of ballots (e.g., via the one or more processors 120, via the optical scan machine 102, via the output production process 194, via the attached digital display 128, via the attached poll tape printer 170, etc.). In some embodiments, the optical scan machine 102 only produces the output when in test mode (not normal mode). The output may be machine-readable (e.g., in the form of a QR code) and/or human-readable (e.g., in the form of a poll tape).

Examples of human-readable optical scanner output 156 include text, such as a paragraph indicating if a voting machine is working properly; or, if not working properly, describing a problem with the optical scan machine 102. In another example, the human-readable output includes indications of total numbers of votes for individual candidates. In yet another example, the human-readable output includes one or more images of ballots of the plurality of ballots.

Examples of machine-readable optical scanner output 156 include: a quick response (QR) code; a barcode; and/or a commitment (e.g., a hash value configured to be read by a verifier application, encrypted information, etc.). Any of these examples may encode information, such as total numbers of votes for candidates, image information of ballots, times that ballots were cast and/or scanned, etc.

Additionally or alternatively, in human-readable and/or machine-readable form, the optical scanner output 156 may include: a binary indication of whether a optical scan machine 102 has passed a test; a binary indication of whether a voting system (e.g., including the optical scan machine 102, etc.) has passed a test; a summary of the information of a plurality of ballots; the information of the first ballot and/or the information of the second ballot; and/or image(s) of ballot(s).

In some embodiments, producing the output includes performing a transformation on the aggregated information of the plurality of ballots, for instance through use of processors 120 and execution of a ballot synthesis process 192 and the output production process 194.

In some embodiments, the memory card of the optical scan machine 102 is transported to the central voting management server 152, as displayed in block 265. Then, output is produced there as described for blocks 245 and 255.

At block 270, it is determined if the voting system has passed a test. In some embodiments, the determination is based on the comparison of the synthetic output 155 and the optical scanner output 156. For example, the simulated aggregation produced by the auxiliary computing device 132 and the actual aggregation made by the optical scan machine 102 may be compared to make the determination.

In some embodiments, if the optical scan machine 102 has passed the test, the optical scan machine 102 is also sealed (e.g., by human administrator) such that a memory card cannot be removed from the optical scan machine 102 without breaking the seal. Advantageously, this improves security of the system because it allows verification that the seal has not been broken (e.g., that the optical scan machine 102 has not been tampered with) prior to the use of the optical scan machine 102 in an upcoming election.

At block 275, which is exercised especially in combination with optional block 205 (e.g., advantageously to improve computer security), the optical scan machine 102 is placed in normal mode, i.e., the optical scan machine 102 is removed from test mode. The optical scan machine 102 may be placed in the normal mode by a human administrator.

It should be understood that not all blocks and/or events of the example method 200 are required to be performed. The example method 200 may include additional, less, or alternate functionality, including that discussed elsewhere herein.

### ADDITIONAL EXAMPLES

The following provide additional examples of the claimed technology. Note that in each example, we say that an election official Alice conducts a series of steps. Each example should be understood to also reflect the case where Alice contracts a worker or a vendor to perform all or some of these steps on her behalf, or where her performance of the step is subject to computerized assistance or replacement. Note also that each manifestation describes certain behavior by the machine. This should be understood to include when this is the machine's default behavior, but it should also be understood to include when the machine behaves in this fashion because a special set of behaviors has been triggered, such as a “testing mode.”

### Additional Example 1

Alice prepares a test deck of marked ballots (i.e., a set of one or more ballots which contains markings, chosen according to some specific procedure). She scans the first ballot through the optical scan machine 102. The optical scan machine 102 interprets the ballot using an optical scanner and one or more processors and optionally records it to memory. The voting machine then displays using an attached digital display or printer which candidates were interpreted as receiving votes on the ballot just cast (i.e., the contents of the most recent ballot is the output produced at optional block 235). Alice confirms that the optical scan machine 102 displayed the correct interpretation of the ballot. Alice then repeats the process with each following ballot.

### Additional Example 2

Alice prepares a test deck of marked ballots. She scans each ballot through the optical scan machine 102. The optical scan machine 102 interprets the ballot using an optical scanner and one or more processors and either records it to memory or increments, in its memory, a tally of the number of votes received by each candidate. The optical scan machine then displays using an attached digital display or printer a running tally of the number of votes received by each candidate (e.g., the running tally is the output produced at block 235). Alice confirms that candidates' vote totals are as expected after each ballot is cast, or that they increase when (and only when) she casts a ballot marked for that candidate.

### Additional Example 3

Alice prepares a test deck of marked ballots. She scans each ballot through the optical scan machine 102. The optical scan machine 102 interprets each ballot using an optical scanner and one or more processors and stores that interpretation in its memory. Once the full deck is scanned, the optical scan machine 102 reports its interpretation for each individual ballot as reflected in its memory through use of an attached display, production of a physical record, output of electronic data, or some combination thereof. Alternately, Alice detaches a memory device from the voting machine and attaches it to a different computer which reports the voting machine's interpretation for each ballot as reflected in the memory device. Alice confirms that the voting machine's interpretation for each ballot is correct. Recall especially for this example that Alice may use a computer to assist or replace her performance of some of these tasks. For example, Alice may rely on a computer program to generate the test deck of marked ballots to use and subsequently use that same program to ensure that the output interpretation of each ballot matches what was generated.

### Additional Example 4

Alice prepares a test deck of marked ballots and uses a computer such as the auxiliary computing device 132 to prepare a commitment (e.g., a hash, an encryption, etc.) to the ballots' contents. She then scans each ballot through the optical scan machine 102. As in example 3 above, the optical scan machine 102 interprets each ballot using an optical scanner and one or more processors and stores that interpretation in its memory. Once the full deck is scanned, the optical scan machine 102 uses the same procedure as Alice and one or more of its internal processors to derive a commitment to the contents of the set of ballots. The optical scan machine 102 outputs this commitment using an attached display, production of a physical record, output of electronic data, or some combination thereof. Alice confirms that the commitment matches the one she expected.

### Additional Example 5

Alice prepares a test deck of marked ballots and uses a computer such as the auxiliary computing device 132 to derive a commitment to the ballots' contents. She inputs this commitment into the optical scan machine 102 and scans each ballot through. As in the previous example, the optical scan machine 102 interprets each ballot using an optical scanner and one or more processors and stores that interpretation in its memory. Once the full deck is scanned, the optical scan machine 102 uses the same procedure as Alice and one or more of its internal processors to derive a commitment to the contents of the set of ballots. The optical scan machine 102 then checks (using one or more processors) and reports (using an attached display, production of a physical record, output of electronic data, or some combination thereof) whether the commitment it derived matches the one input by Alice.

### Additional Example 6

Alice prepares a ballot by marking a different symbol in each candidate's voting target (e.g., a voting box on a ballot) and scans it through the optical scan machine 102. The optical scan machine 102 then takes an image of the ballot. The optical scan machine 102 then outputs, for each candidate, an image of the associated voting target and the symbol it contains. Alice ensures that the correct symbol is associated with each candidate.

### Additional Example 7

Alice tests a optical scan machine 102 and discovers that it is properly configured. Alice has the optical scan machine 102 derive a commitment to its configuration (e.g., a hash of the election definition in use) using its memory and one or more processors, then has the machine output this commitment using an attached display, production of a physical record, output of electronic data, or some combination thereof. Alice then goes to another voting machine and has it also generate and display a commitment to its configuration using the same methods as the original machine. Alice checks whether the configurations match between machines in order to identify whether the second machine is also properly configured to count the applicable ballot style.

### Additional Example 8

Alice uses a ballot-marking device (BMD) to print out a test deck of filled-out ballots. The BMD prints each ballot with machine readable information, for example a QR code, which either contains or commits to the intended interpretation of the ballot. Alice then scans each ballot through a ballot tabulating machine (e.g., the optical scan machine 102). The ballot tabulating machine interprets each ballot using an optical scanner and one or more processors, and also interprets the data conveyed in the ballot's attached QR code. Then, using one or more processors, the machine compares its interpretation of the former to its interpretation of the latter and evaluates the two for consistency. If an inconsistency is found, the machine alerts Alice through an attached display, production of a physical record, output of electronic data, or some combination thereof.

### Additional Example 9

Alice uses a BMD to print out a test deck of filled-out ballots. The ballots are filled out according to a pattern that is predictable in some way (e.g., a pattern derived by the BMD's internal computer from the election definition or from a seed value chosen by Alice). Alice then scans each ballot through a ballot tabulating machine. The ballot tabulating machine interprets each ballot using an optical scanner and one or more processors, saves the interpretations to its internal memory, and checks (using one or more processors, access to that memory, access to the same seed value or election definition, and access to the same procedure as the BMD) whether the test deck retained in its memory is consistent with the predictable way a test deck should be filled out. If an inconsistency is found, the ballot tabulating machine alerts Alice through an attached display, production of a physical record, output of electronic data, or some combination thereof.

In each of these examples 1-9, Alice has made use of output from the optical scan machine 102 other than the final tally of the votes included in the test deck. In most cases, this has allowed her to determine whether the machines being tested interpret each ballot correctly, as opposed to current practice which would only confirm that the machine had arrived at the correct aggregate count of votes. Through providing a more “verbose” output, the techniques described herein allow her to more directly examine the optical scan machine's 102 configuration for correctness.

### Additional Aspects

In some embodiments, the output (e.g., produced at block 235 or 255) is provided on the poll tape (e.g., printed by poll tape printer 170) or a display of the optical scan machine 102 and/or optical scan machine 102. The output may be derived from the optical scan machine 102's configuration or its interpretation of ballots on an individual (e.g., non-tallied) basis. Examples include:
a) an output of a particular candidate or set of candidates interpreted as having been voted on a particular ballot or set of ballots,
b) an output of a particular ballot or set of ballots interpreted as having been marked for a particular candidate or set of candidates,
c) an output which replicates the actual marking made in, through, or beside the voting target associated with each candidate on one or more ballots,
d) information derived from the data or metadata of the machine's 102 configuration, for example a mapping of targets to candidates or a configuration timestamp, or
e) information summarizing, fingerprinting, or committing to any of the above, such as a hash or digital signature of the information in either human-readable or machine-readable format.

Additionally, in some embodiments, in the test mode, the optical scan machine 102 may:
a) maintain a record in memory that includes tabulated ballots in some deterministic, predictable, or known order, such as the order they were cast or an order which is sorted according to their contents,
b) process and retain images of the contents of the ballot's targets for use in evaluating the optical scan machine's 102 configuration,
c) accept a specification or description of a ballot or test deck's contents and compare it to the cast ballot or deck of ballots,
d) accept a commitment to a specification or description of a test deck's contents, or a seed or other value from which one can be derived, and determine whether it is consistent with the cast deck of ballots, or
e) render information derived from the interpretation of ballots on the optical scan machine 102 display.

In addition, in some embodiments, determining if the optical scan machine 102 has passed the test (e.g., block 270) uses functionalities other than tabulation and the production of a poll tape, whether in the optical scan machine's 102 test or normal mode. Examples include:
a) maintaining a record in memory that includes tabulated ballots in some deterministic, predictable, or known order, such as the order they were cast or an order which is sorted according to their contents,
b) processing and retaining images of the contents of the ballot's targets for use in evaluating the optical scan machine's 102 configuration,
c) accepting a specification or description of a ballot or test deck's contents and comparing it to the cast ballot or deck of ballots,
d) accepting a commitment to a specification or description of a test deck's contents, or a seed or other value from which one can be derived, and determining whether it is consistent with the cast deck of ballots, or
e) rendering information derived from the interpretation of ballots on the optical scan machine 102 display.

In some embodiments, the output may include output additional or alternative to the poll tape and/or display of the optical scan machine 102 and/or optical scan machine 102. For example, the output may include cast vote records (CVRs) (e.g., the information associated with the ballot is included in a CVR file). Some such examples may include:
a) an output of a particular candidate or set of candidates interpreted as having been voted on a particular ballot or set of ballots,
b) an output of a particular ballot or set of ballots interpreted as having been marked for a particular candidate or set of candidates,
c) an output which replicates the actual marking made in, through, or beside the voting target associated with each candidate on one or more ballots,
d) information derived from the data or metadata of the optical scan machine's 102 configuration, for example a mapping of targets to candidates or a configuration timestamp, or
e) information summarizing, fingerprinting, or committing to any of the above, such as a hash or digital signature of the information in either human-readable or machine-readable format.

### Additional Example Embodiments

Aspect 1. A computer system for use in checking a voting system and/or voting machine, the computer system comprising:
one or more processors; and
one or more non-transitory memories, the one or more non-transitory memories having stored thereon computer-executable instructions that, when executed by the one or more processors, cause the one or more processors to:
   (I) receive information associated with a ballot;
   (II) analyze the information associated with the ballot to thereby: (i) determine which candidates should receive votes, and/or (ii) identify locations of certain text or symbols on the ballot;
   (III) store, to the one or more non-transitory memories: (i) the determined candidates, and/or (ii) the identified location of the certain text or symbols on the ballot;
   repeat (I)-(III) with one or more additional ballots;
   synthesize, for each ballot: (i) the determined candidates, and/or (ii) the identified location of the certain text or symbols on the ballot to thereby retain information which would be lost in tabulation; and
   output information produced by the synthesis via: a display, physical media printer, and/or data port.

Aspect 2. A computer device for use in testing a voting system and/or voting machine without the use of test ballots the computer device comprising one or more processors configured to:
receive a configuration specifying how a voting machine should interpret ballots in an upcoming election;
process contents of the configuration; and
determine an output based on the processed contents of the configuration;
output the output via: a display, physical media printer, and/or data port.

Aspect 3. A computer device for use in testing a voting system and/or voting machine without the use of test ballots the computer device comprising one or more processors configured to:
receive, via a data port or wireless connection, a configuration specifying how a voting machine should interpret ballots during an upcoming election;
interpret the contents of the configuration;
evaluate whether the configuration satisfies certain rules (e.g. ensuring that all voting targets are the same size, ensuring that candidates in the same contest have targets that are located near one another on the ballot, ensuring that each target maps to precisely one candidate and each candidate has precisely one target, ensuring that no two targets overlap, etc.);
determine an output based on the evaluation; and
output the output via: a display, physical media printer, and/or data port.

### Additional Example Embodiments—Checking the Configuration

Advantageously, certain embodiments may check whether the configuration 124, 164 satisfies configuration rules.

As mentioned above, the configuration 124, 164 may include information of: contests of the election (e.g., a presidential contest, a senate contest, etc.), candidate(s) in each contest, maximum number of allowed votes per contest, the mapping between voting targets on the ballot and the corresponding candidate, etc.

Examples of the configuration rules include: that all voting targets (e.g., voting boxes on ballots) which appear on the ballot are the same size; that candidates in the same contest have targets that are located contiguously to one another on the ballot, such that no candidate from another contest is located between them and neighboring targets from the same contest are near (e.g., within 2 cm, etc.) of one another; that each target maps to precisely one candidate and each candidate has precisely one target; that no two targets overlap; that the order of contests and/or sections of the ballot conforms to the jurisdiction's rules; that the expected parties appear on the ballot; that candidates' names are spelled consistently across different ballots for the same election; that every ballot contains the expected federal and statewide contests; etc. It may be noted that different jurisdictions may have different configuration rules.

Such checking of the configuration 124, 164 offers numerous advantages that enhance the integrity, efficiency, and accuracy of the election process while ensuring compliance with jurisdiction-specific requirements. By evaluating whether a configuration 124, 164 satisfies configuration rules, certain embodiments of the invention achieve substantial improvements over existing systems. Specific examples follow below.

Enhanced Election Integrity and Compliance: The ability to systematically evaluate the configuration 124, 164 against configuration rules ensures that ballots adhere to jurisdictional requirements. For instance, verifying that the order of contests, the arrangement of voting targets, and the inclusion of mandatory contests meet jurisdictional mandates minimizes the risk of improper configurations that may lead to voter confusion, legal challenges, or invalidated ballots. Ensuring consistency in candidate names and party identification further mitigates errors that could undermine voter confidence or create technical discrepancies in vote tabulation.

Improved Accuracy in Ballot Presentation: Such checking leverages processor-based evaluation to ensure precision in mapping voting targets to candidates and verifying target sizes and layouts. This prevents issues such as overlapping targets, which can lead to miscounted votes, and ensures that candidates within the same contest are grouped appropriately to maintain clarity for voters and help to detect misconfigurations that would result in candidates receiving votes from the wrong voting targets. Such safeguards promote usability and reduce the need for manual corrections or debugging during the ballot creation process.

Adaptability to Jurisdictional Variability: Different jurisdictions may impose distinct rules regarding ballot design and configuration. Some embodiments advantageously adapt to various configurations and validate them against jurisdiction-specific rules ensuring applicability across diverse regulatory environments. This flexibility is particularly advantageous in elections spanning multiple jurisdictions where uniform compliance with localized requirements is critical (e.g., in states where different counties use different models of voting machines which use different ballot layouts or have different configuration requirements).

Error Reduction and Prevention: The parsing and interpretation of configurations, coupled with rule-based evaluation, proactively identifies errors, such as inconsistent candidate naming, incorrect organization of contests, or missing mandatory voting sections. By addressing these issues early in the configuration process, the invention reduces the likelihood of faults propagating to printed ballots and voting systems, thereby preventing costly fixes or election-day disruptions.

Scalability and Integration with Auxiliary Systems: The described functionality integrates seamlessly with various computational systems 102, 132, 152, including election management software, ballot proofing systems, and optical character recognition (OCR)-based input systems. This interoperability ensures effectiveness in large-scale elections or complex environments where multiple systems interact. By supporting diverse input methods—such as manual data entry, wireless connections, and OCR-based parsing—the configuration checking described herein accommodates varying technological setups and enhances overall usability.

Promotion of Transparency and Accountability: Outputting information confirming the configuration's 124, 164 compliance with jurisdictional rules enhances transparency for election officials, stakeholders, and voters. This fosters confidence in the integrity of the ballot preparation process and simplifies reporting obligations. Additionally, the clear documentation of rule satisfaction minimizes opportunities for disputes or ambiguity regarding compliance.

In some examples, the configuration 124, 164 is checked in conjunction with the testing of the voting machine as shown in FIG. 2.

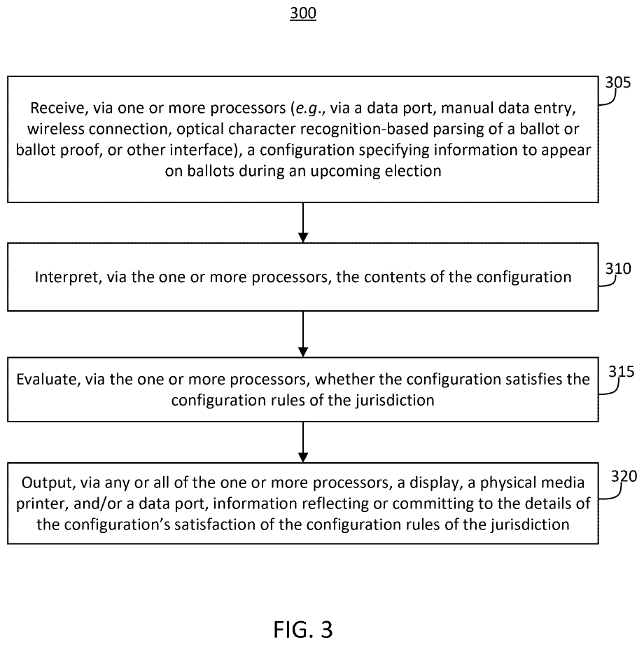

FIG. 3 shows an example method 300 for checking a configuration 124, 164. It should be appreciated that the example method 300 may be performed, wholly or partially, by one or more of the optical scan machine 102, auxiliary computing device 132, and/or the central voting management server 152.

The example method 300 may begin at block 305 when the one or more processors 140, 160 receive (e.g., via a data port, manual data entry, wireless connection, optical character recognition-based parsing of a ballot or ballot proof, or other interface), a configuration 124, 164 specifying information to appear on ballots during an upcoming election. In some examples, the received configuration 124, 164 is the configuration 124 sent from the optical scan machine 102 (e.g., via network 104 and/or auxiliary computing device 132). In some examples, the block 305 may determine a configuration format, such as JSON, XML, JPEG, TIFF, text, or other format. The block 305 may determine if the configuration is contained in metadata, is formed of encoded decode, etc. The block 305 may be employ a configuration parser to identify the configuration. The block 305 may be configured to analyze various different configuration types, allowing for processing various different types of ballots without needing to reconfigure the process 300.

At block 310, the one or more processors 140, 160 interpret the contents of the configuration 124, 164. The system 102, 132, 152 performing the method may log the interpreted contents of the configuration to memory. As described above, the contents of the configuration may include information of: contests of the election (e.g., a presidential contest, a senate contest, etc.), candidate(s) in each contest, maximum number of allowed votes per contest, the mapping between voting targets on the ballot and the corresponding candidate, etc. Interpretation of the configuration would include the extraction of some or all of this information, and may additionally include other validation steps such as checking the configuration for an authentication code or cryptographic signature.

At block 315, the one or more processors 140, 160 evaluate whether the configuration 124, 164 satisfies the configuration rules of the jurisdiction. See discussions herein for example configuration rules. Information in the configuration 124, 164 may additionally or instead be compared to ground truth information (e.g., stored in the voting information database 158, etc.) or compared to information in other configuration to ensure consistency and identify any discrepancies that could assist in identifying an error.

At block 320, information reflecting or committing to the details of the configuration's 124, 164 satisfaction of these rules may be output by any or all of the one or more processors 140, 160, the display 148, 168, a physical media printer (e.g., such as connected to the auxiliary computing device 132 or the central voting management server 152), and/or data port (e.g., a data port of the auxiliary computing device 132 or the central voting management server 152). In some examples, the block 320 may additionally determine test mode instructions from analysis of the configuration data, where those test mode instructions are provided to the block 205 and/or 210 for execution during process 200.

It should be understood that not all blocks and/or events of the example method 300 are required to be performed. The example method 300 may include additional, less, or alternate functionality, including that discussed elsewhere herein.

### Further Illustrative Example of Checking the Configuration

For still further illustration, consider one example method for use in testing a configuration. Specifically, this method involves a digital system receiving a configuration detailing which information should appear on election ballots. This information may be input or received through various electronic or manual methods including direct data entry, wireless connections, electronic parsing of ballots, or ballot proofs, among others.

Once received, the configuration is then digitally interpreted by appropriate processor systems to verify the content and check it thoroughly against predefined requirements or election rules established by the pertinent jurisdiction or governmental body. This evaluation step ensures that the received configuration aligns completely with jurisdiction-specific election standards and constraints for accuracy, compliance, and legitimacy.

Lastly, the system generates and outputs confirmation or details reflecting the configuration evaluation results. This output may be provided in various formats, including on digital screens, through a physical printer producing printed documentation, or via digital data outputs or ports, thereby ensuring clarity and recorded proof that the configuration meets all required jurisdictional election standards.

In one example implementation of the above, there may be:
A computer-implemented method for use in testing a configuration which specifies the contents of an upcoming election comprising an election management system or other auxiliary computational system:
receiving via one or more processors (e.g., through a data port, manual data entry, wireless connection, optical character recognition-based parsing of a ballot or ballot proof, and/or other interface), a configuration specifying information to appear on ballots during an upcoming election;
interpreting, via the one or more processors, the contents of the configuration;
evaluating, via one or more processors, whether the configuration satisfies the configuration rules of the jurisdiction; and
outputting, via any or all of the one or more processors, an attached digital screen, physical media printer, and/or data port, information reflecting or committing to the details of the configuration's satisfaction of these rules.

### OTHER MATTERS

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A computer-implemented method for use in checking a voting system and/or voting machine, the computer-implemented method comprising:
receiving, via one or more processors, information associated with one or more ballots;
analyzing, via the one or more processors, the information associated with the one or more ballots to thereby: (i) determine which candidates should receive votes, and/or (ii) identify locations of certain text or symbols on the one or more ballots;
determining, via the one or more processors, an output based on: (i) the determined candidates, and/or (ii) the identified location of the certain text or symbols on the one or more ballots;
outputting, via the one or more processors, the output via: a display, physical media printer, and/or data port; and
determining, based on the output, whether the voting machine has passed a test.

2. The computer-implemented method of claim 1, wherein the output is machine-readable, and includes:
a quick response (QR) code;
a barcode; or
a hash value configured to be read by a verifier application.

3. The computer-implemented method of claim 1, wherein the output is human-readable.

4. The computer-implemented method of claim 1, wherein the output includes:
a binary indication of whether the voting machine has passed the test;
a binary indication of whether the voting system has passed a test;
a summary of the information of the one or more ballots;
the information of one or more ballots; or
an image of one or more ballots.

5. The computer-implemented method of claim 1, wherein the analyzing the information associated with the one or more ballots includes performing a transformation on aggregated information of a plurality of ballots.

6. The computer-implemented method of claim 1, wherein the information associated with the one or more ballots includes:
indications of votes for candidates in respective contests;
an indication of a date and/or time that a first ballot was cast; and/or
an indication of a date and/or time that the first ballot was scanned.

7. The computer-implemented method of claim 1, further including:
receiving, via the one or more processors, a verification document depicting expected or intended contents of the one or more ballots; and
determining, via the one or more processors, if the voting system has passed a test based on: (i) the verification document, and (ii) the information associated with the one or more ballots interpreted by the voting system; and
wherein the output includes an indication of if the voting system has passed the test.

8. The computer-implemented method of claim 1, further including outputting, via the one or more processors, via a display, physical media printer, and/or data port:
information derived from data or metadata of a configuration of the voting system and/or voting machine; and/or
information of the configuration, wherein the information of the configuration specifies how the voting system and/or voting machine interpret ballots.

9. The computer-implemented method of claim 1, further comprising:
prior to the receiving the information associated with the one or more ballots, placing, via the one or more processors, the voting machine in a test mode; and
wherein the determining the output is performed in response to the voting machine being in the test mode.

10. The computer-implemented method of claim 1, further comprising:
prior to the receiving the information associated with the one or more ballots: (i) placing, via the one or more processors, the voting machine in a test mode, and (ii) sealing the voting machine such that a memory card of the voting machine cannot be removed without breaking a seal; and
subsequent to the determining the output, placing, via the one or more processors, the voting machine in a normal mode.

11. The computer-implemented method of claim 1, further comprising:
prior to the receiving the information associated with the one or more ballots: (i) placing, via the one or more processors, the voting machine in a test mode, and (ii) sealing a voting machine such that a memory card of the voting machine cannot be removed without breaking a seal;
determining, based on the output, that the voting machine has passed the test; and
in response to the determination that the voting machine has passed the test, placing, via the one or more processors, the voting machine in a normal mode.

12. A computer device for use in checking a voting system and/or voting machine, the computer device comprising one or more processors configured to:
receive information associated with a ballot;
analyze the information associated with the ballot to thereby: (i) determine which candidates should receive votes, and/or (ii) identify locations of certain text or symbols on the ballot;
determine an output based on: (i) the determined candidates, and/or (ii) the identified location of the certain text or symbols on the ballot;
output the output via: a display, physical media printer, and/or data port; and
determine, based on the output, whether the voting machine has passed a test.

13. The computer device of claim 12, wherein the output is machine-readable, and includes:
a quick response (QR) code;
a barcode; or
a hash value configured to be read by a verifier application.

14. The computer device of claim 12, wherein the output is human-readable.

15. The computer device of claim 12, wherein the one or more processors are further configured to:
prior to the receiving the information associated with the ballot, place the voting machine in a test mode; and
produce the output in response to the voting machine being in the test mode.

16. The computer device of claim 12, further comprising a display device configured to display the output.

17. A computer system for use in checking a voting system and/or voting machine, the computer system comprising:
one or more processors; and
one or more non-transitory memories, the one or more non-transitory memories having stored thereon computer-executable instructions that, when executed by the one or more processors, cause the one or more processors to:
receive information of a plurality of ballots;
analyze the information associated with the plurality of ballots to thereby: (i) determine which candidates should receive votes, and/or (ii) identify locations of certain text or symbols on individual ballots included in the plurality of ballots;
synthesize the analysis to thereby retain information that would be lost by tabulation;
determine an output based on the synthesis;
output the output via: a display, physical media printer, and/or data port; and
determine, based on the output, whether the voting machine has passed a test.

18. The computer system of claim 17, wherein the synthesized information includes the determined candidates.

19. The computer system of claim 17, the one or more non-transitory memories having stored thereon computer-executable instructions that, when executed by the one or more processors, further cause the one or more processors to:
prior to the receiving the information associated with the plurality of ballots, place the voting machine in a test mode; and
produce the output in response to the voting machine being in the test mode.

20. The computer system of claim 17, the one or more non-transitory memories having stored thereon computer-executable instructions that, when executed by the one or more processors, further cause the one or more processors to:
receive a configuration;
interpret contents of the configuration;
evaluate whether the configuration satisfies the configuration rules of a jurisdiction, wherein the configuration rules of the jurisdiction include that:
all voting targets which appear on a ballot are a same size;
candidates in a same contest have targets that are located near one another on the ballot;
each target maps to precisely one candidate and each candidate has precisely one target;
no two targets overlap;
order of contests and/or sections of the ballot conforms to the jurisdiction's rules;
expected parties appear on the ballot;
candidates' names are spelled consistently across different ballots; and/or
every ballot contains the expected federal and statewide contests; and
output, an indication of if the configuration satisfies the configuration rules of the jurisdiction to any or all of the display, physical media printer, and/or data port.
